(19) United States
(12) Patent Application Publication
(10) Pub. No.: US 2015/0168775 A1
(43) Pub. Date: Jun. 18, 2015

(54) DIRECT TYPE BACKLIGHT MODULE

(71) Applicant: HON HAI PRECISION INDUSTRY CO., LTD., New Taipei (TW)

(72) Inventor: SHAO-HAN CHANG, New Taipei (TW)

(21) Appl. No.: 14/517,596

(22) Filed: Oct. 17, 2014

(30) Foreign Application Priority Data
Dec. 16, 2013 (CN) 201310684812.8

(51) Int. Cl. G02F 1/1335

(52) U.S. Cl. CPC G02F 1/133524; G02F 1/133605; G02F 1/133603

(57) ABSTRACT

A backlight module includes a back cover, a reflective sheet, a lamp shade, a plurality of light sources, a collimating lens, a reflector and a light-guiding plate positioned facing the plurality of light sources. At least one prismatic-shaped protrusion portion and at least two light incident portions are defined on the surface of the light-guiding plate facing the light sources. The reflector is positioned between the light source and one light incident portion. The reflector defines several light transmission holes. The collimating lens is positioned between the light source and the reflector.

### FIELD

The subject matter herein generally relates to the field of liquid crystal displays, and particularly to a direct type backlight module.

### BACKGROUND

In a liquid crystal display (LCD) device, the liquid crystal is a substance that does not radiate light. Rather, the liquid crystal relies on receiving light from a light source in order to display images and data. In the case of a typical LCD device, a backlight module powered by electricity, supplies the needed light.

The known backlight module can be divided into a direct-light type and an edge-light type according to the location of the light source. In the direct-light type backlight module, the light sources are located under the LCD panel corresponding to an entire area of the LCD panel. A display apparatus having the direct-light type backlight module may have a relatively narrow bezel. In the edge-light type backlight module, the light sources are located under the LCD panel at a position corresponding to an edge portion of the LCD panel. A display apparatus having the edge-light type backlight module may be relatively thin.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a top view of a backlight module according to a first embodiment of the present disclosure.

FIG. 2 is an exploded, isometric view of the backlight module as shown in FIG. 1.

FIG. 3 is a cross-sectional view of the backlight module taken along a line III-III of FIG. 1.

FIG. 4 is a cross-sectional view of the backlight module taken along a line IV-IV of FIG. 1.

FIG. 5 is an enlarged view of a circled portion V of the backlight module as shown in FIG. 4.

FIG. 6 is a perspective view of a reflector of the backlight module as shown in FIG. 2.

FIG. 7 is a perspective view of a light guiding plate of the backlight module as shown in FIG. 2.

FIG. 8 is a cross-sectional view of the backlight module according to the first embodiment of this disclosure.

FIG. 9 is a cross-sectional view of a backlight module according to a second embodiment of this disclosure.

FIG. 10 is a cross-sectional view of a backlight module according to a third embodiment of this disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

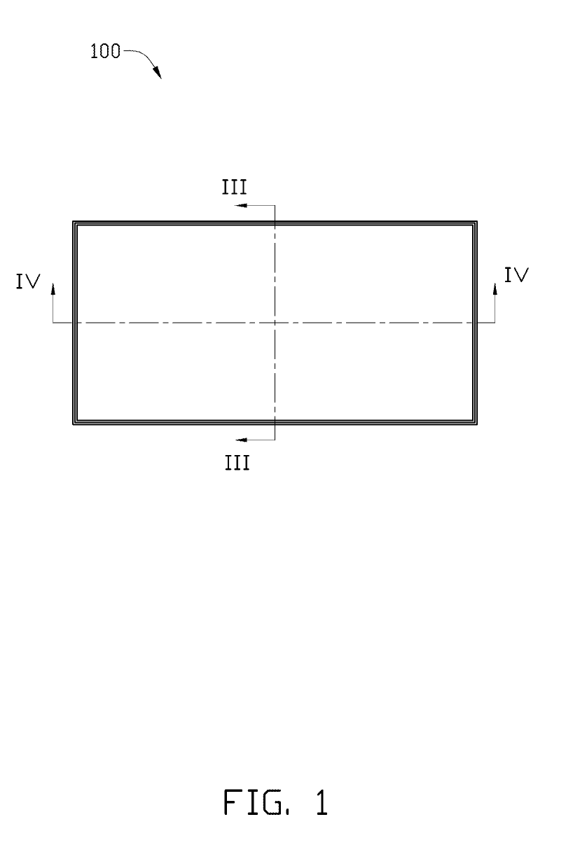

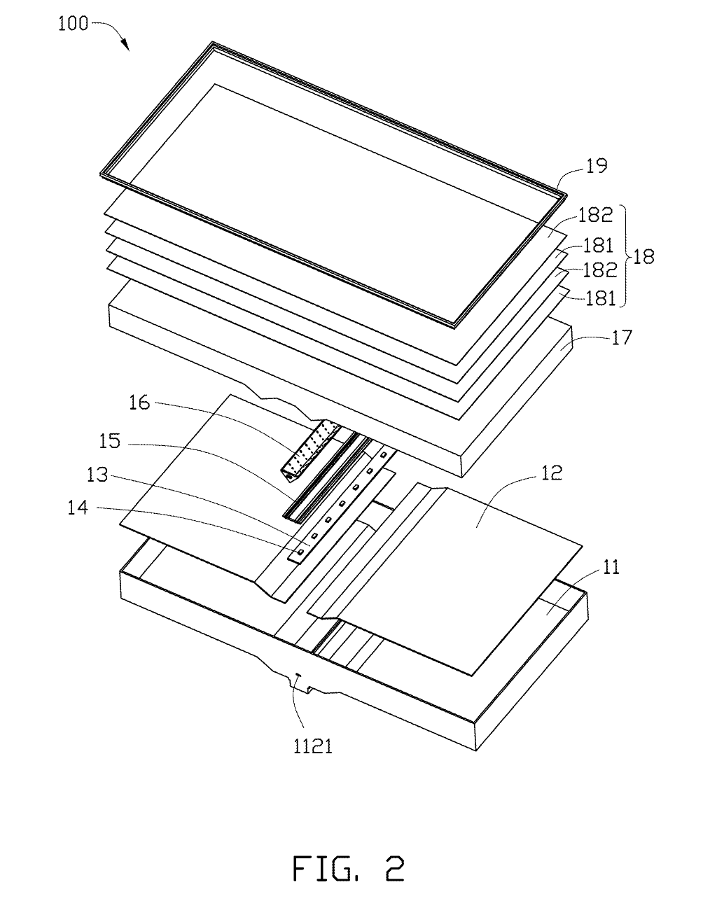

FIG. 1 illustrates a first embodiment of a backlight module 100. FIG. 2 illustrates that the backlight module 100 can include a back cover 11, a reflective sheet 12, a lamp shade 13, a plurality of light sources 14, and a light guiding plate 17. In at least one embodiment, the back cover 11 can be box shaped. The reflective sheet 12 can be attached on an inner surface of the back cover 11. The light source 14 can be a light-emitting diode (LED). The backlight module 100 can further include a collimating lens 15, a reflector 16, an optical film 18, and a plastic frame 19. The lamp shade 13, the light source 14, the collimating lens 15, the reflector 16, the light guiding plate 17, and the optical film 18 can be accommodated in the back cover 11 in order. The light guiding plate 17 can be positioned facing the light source 14.

The optical film 18 can include a number of complementary optical elements. In at least one embodiment, the optical film 18 can include two diffusion sheets 181 and two prism sheets 182. The diffusion sheets 181 and the prism sheets 182 can be positioned one by one in an alternating fashion. In other embodiments, more than two diffusion sheets 181 and prism sheets 182 can be included. The plastic frame 19 can be a rectangular frame which can define an opening in the central portion.

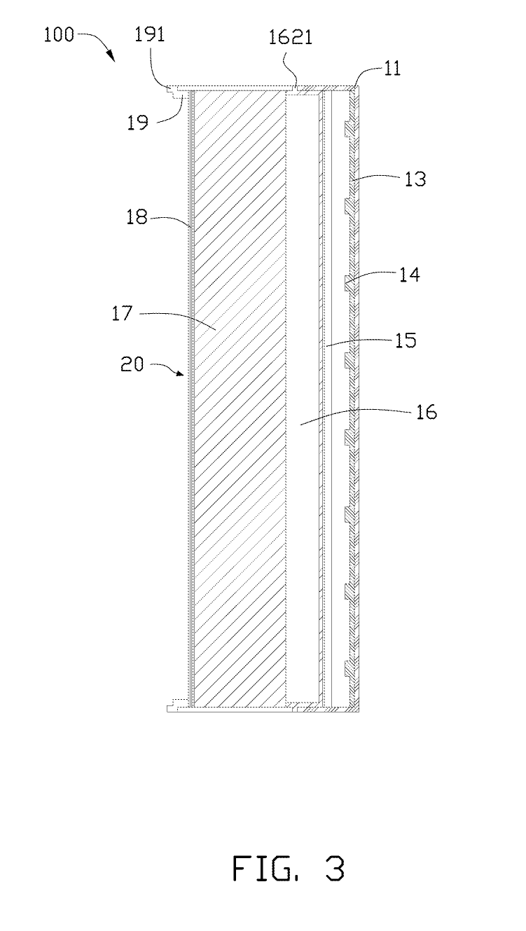

FIG. 3 illustrates that the plastic frame 19 and the back cover 11 can cooperatively define a receiving space 20 for receiving the lamp shade 13, the light source 14, the collimating lens 15, the reflector 16, the light guiding plate 17, and the optical film 18. In at least one embodiment, the plastic frame 19 can define at least one rim 191 protruding around the plastic frame 19 configured for holding a liquid crystal panel (not shown).

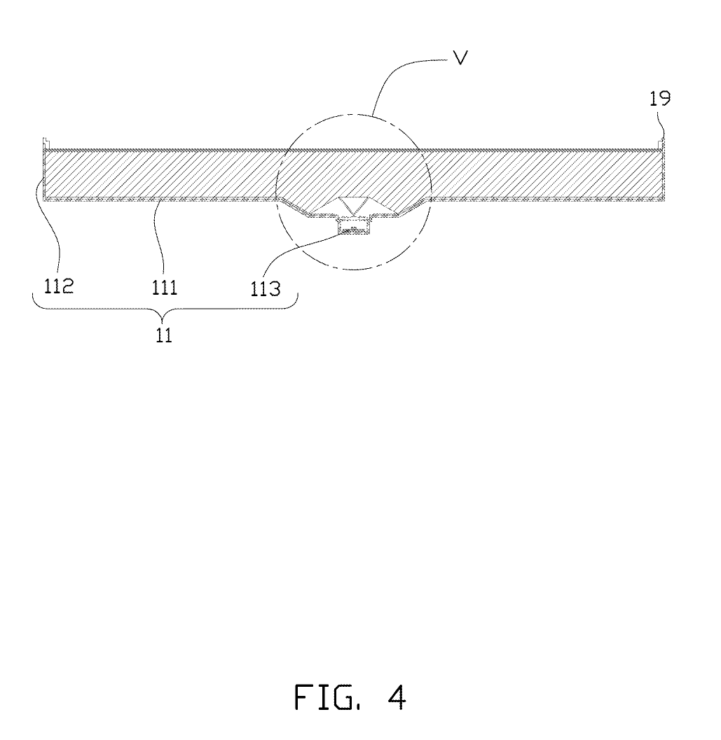

FIGS. 2 and 4 illustrate that the back cover 11 can include a bottom base 111, four first sidewalls 112 connected with the bottom base 111, and a recessed portion 113. The four first sidewalls 112 can extend perpendicularly from the edge of the bottom base 111 in one direction. The recessed portion 113 can be positioned in a center portion of the bottom base 111. The four first sidewalls 112 and the bottom base 111 cooperatively form a receiving space. One pair of the first sidewalls 112 facing each other can each define a hole 1121 for retaining the reflector 16 (as shown in FIG. 3).

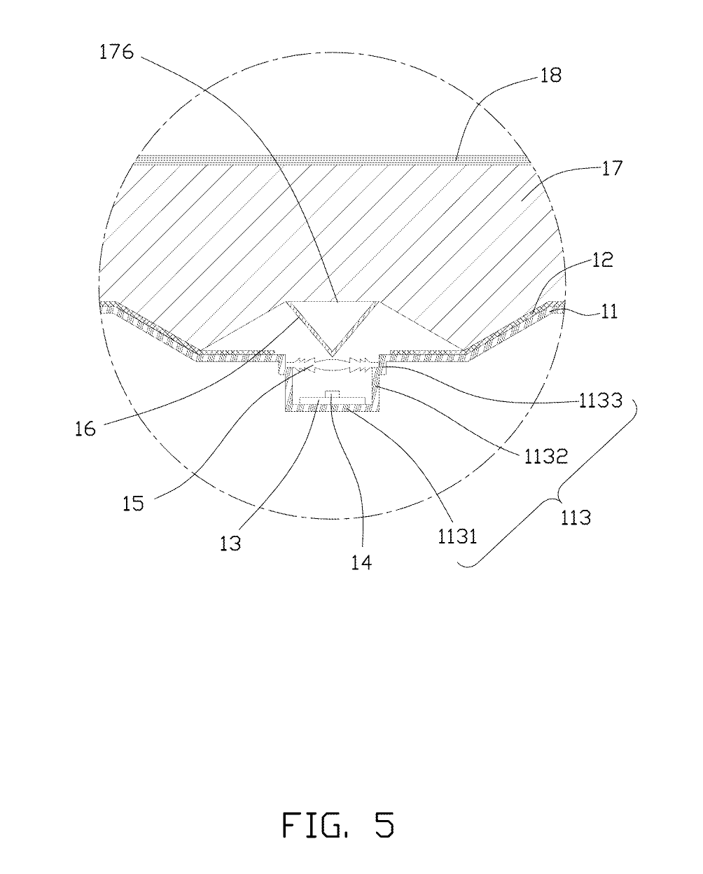

FIG. 5 illustrates that the recessed portion 113 can include two walls 1132, a base 1131, and two shoulders 1133. The base 1131, the two walls 1132, and the two first sidewalls 112 can cooperatively define a rectangular receiving groove for installing the lamp shade 13 and the light source 14. The shape and size of the recessed portion 113 can be substantially the same as that of the lamp shade 13. The two shoulders 1133 can be configured for supporting the collimating lens 15.

The two reflective sheets 12 can be attached on the inner surface of the bottom cover 111 corresponding to a lateral section of the recessed portion 113. The reflective sheets 12 can adjust the transmission direction of the light input to the reflective sheets 12. In at least one embodiment, the lamp shade 13 can be attached with a high-reflectance film (not shown) to prevent light leakage. In addition, a prism sheet (not shown) can be positioned between the lamp shade 13 and the collimating lens 15 to approve the uniformity of the emitting light of the light source 14. The light source 14 can be installed on the lamp shade 13. The lamp shade 13 can be strip-shaped. The lamp shade 13 and the light source 14 can be attached on the base 1131 of the recessed portion 113.

The collimating lens 15 can be installed between the light source 14 and the reflector 16. In at least one embodiment, the collimating lens 15 can be an optical collimating device, such as a convex lens, a cylindrical lens, a biconvex lens, or a combination thereof. The collimating lens 15 can redirect the direct of the light beams of light source 14 and adjust the light beams into parallel emitting light beams.

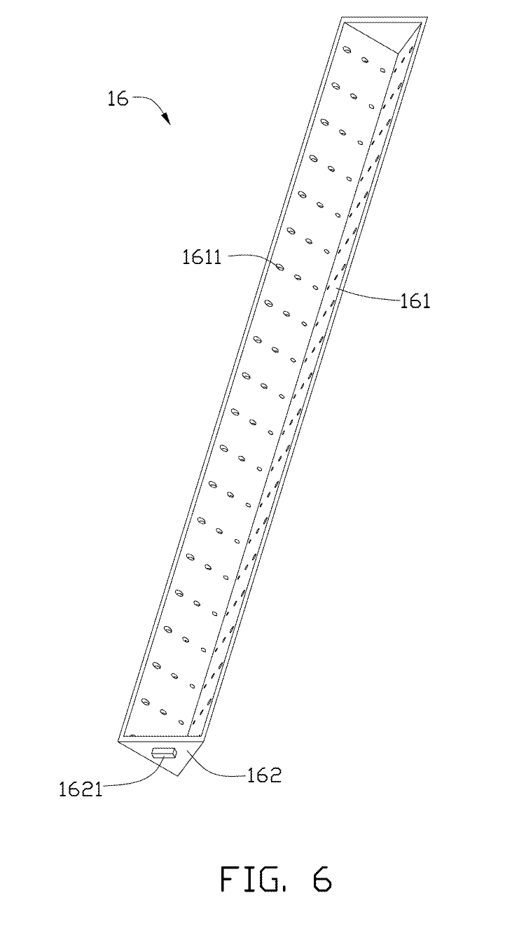

FIG. 6 illustrates that the cross-section of the reflector 16 can be V-shaped. The reflector 16 can include two second sidewalls 161, two third sidewalls 162, and two projections 1621 protruding from the outer surface of the third sidewalls 162. The shape and size of the two projections 1621 can be substantially the same as the two holes 1121 of the back cover 11 (as shown in FIG. 2). The two projections 1621 can mate with the two holes 1121 to secure the reflector 16. The second sidewall 161 can be rectangular plate-shaped. The two second sidewalls 161 can be symmetrically defined and leaning against each other. The two third sidewalls 162 can be triangular and installed on the two ends of the two second sidewalls 161. The two second sidewalls 161 and the two third sidewalls 162 can cooperatively form a prismatic-shaped groove. Each of the second sidewalls 161 can define a plurality of light transmission holes 1611 in a parallel arrangement. Thus, a part of the light emitting from the collimating lens 15 can be transmitted to the section above the reflector 16 through the light transmission holes 1611. In addition, a remainder of the light emitting from the collimating lens 15 can be reflected via the section beside the transmission holes 1611, so that the direction of the remainder of the light emitting from the collimating lens 15 can be redirected.

The plurality of the transmission holes 1611 can be arranged in a circular array or in parallel. In at least one embodiment, the transmission holes 1611 can be oval-shaped or polygonal and arranged in other arrays. The shape and the arrangement of the transmission holes 1611 can be configured for adjusting the luminous flux of the section above the reflector 16.

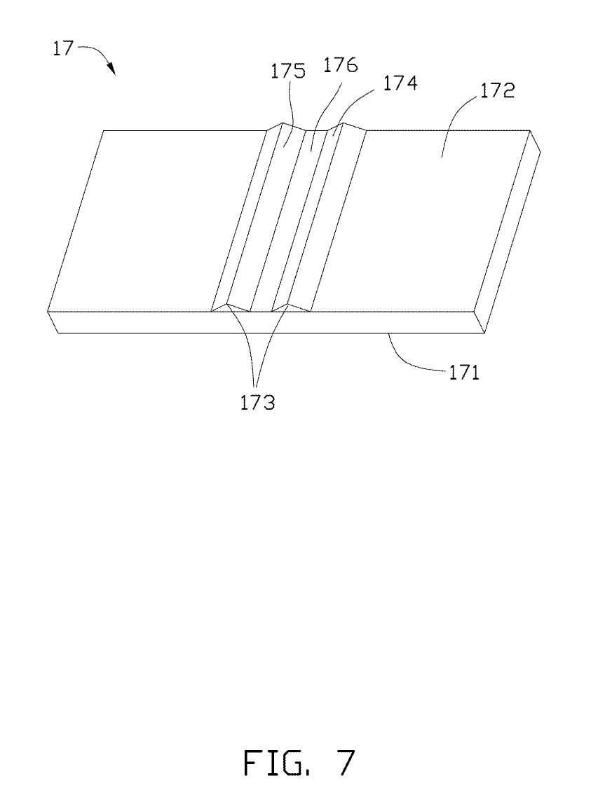

FIG. 7 illustrates that the light guiding plate 17 can be rectangular. The light guiding plate 17 can include a light output surface 171 and a light input surface 172 opposite to the light output surface 171. The light input surface 172 can be adjacent to the light source 14. The central portion of the light input surface 172 can define two protrusion portions 173 spaced from each other. The protrusion portions 173 can be positioned parallel with each other. The protrusion portions 173 can be substantially three-sided prism shaped, and the cross-section can be V-shaped. The protrusion portions 173 can be integrated with the light guiding plate 17.

The surfaces of the two protrusion portions 173 facing each other can be defined as a first light incident portion 174 and a second light incident portion 175. The first light incident portion 174 and the second light incident portion 175 can be inclined with the light input surface 172. An area between the first light incident portion 174 and the second light incident portion 175 can be defined as a third light incident portion 176. The third light incident portion 176 can be parallel with the light input surface 172 of the light guiding plate 17, and can be facing the reflector 16 (as shown in FIG. 6). The third light incident portion 176 can be positioned at a position corresponding to a center portion of the light source 14 (as shown in FIG. 5) so that the light beams transmitting through the reflector 16 can be output to the section above the third light input part 176.

In assembly, the reflective sheets 12 can be attached on the inner surface of the back cover 11. The lamp shade 13 and the light source 14 can be fixed on the inner surface of the recessed portion 113. Next, the two ends of the collimating lens 15 can be secured above the two shoulders 1133, and the two projections 1621 of the reflector 16 can be retained in the two holes 1121 so that the reflector 16 can be received in the back cover 11. Then, the light guiding plate 17 can be positioned above the reflector 16 and the third light incident portion 176 can be located on a section corresponding a center section of the reflector 16. Simultaneously the first light incident portion 174 and the second light incident portion 175 (as shown in FIG. 7) can be located on the two sides of the reflector 16. Finally, the optical film 18 can be located above the light guiding plate 17, and the plastic frame 19 can be positioned above the optical film 18. Simultaneously, the plastic frame 19 can couple with the four sidewalls 112 and form a closed receiving space to receive the lamp shade 13, the light source 14, the collimating lens 15, the reflector 16, the light guiding plate 17, and the optical film 18. Thus, the assembly of the backlight module 100 according to the first embodiment can be completed.

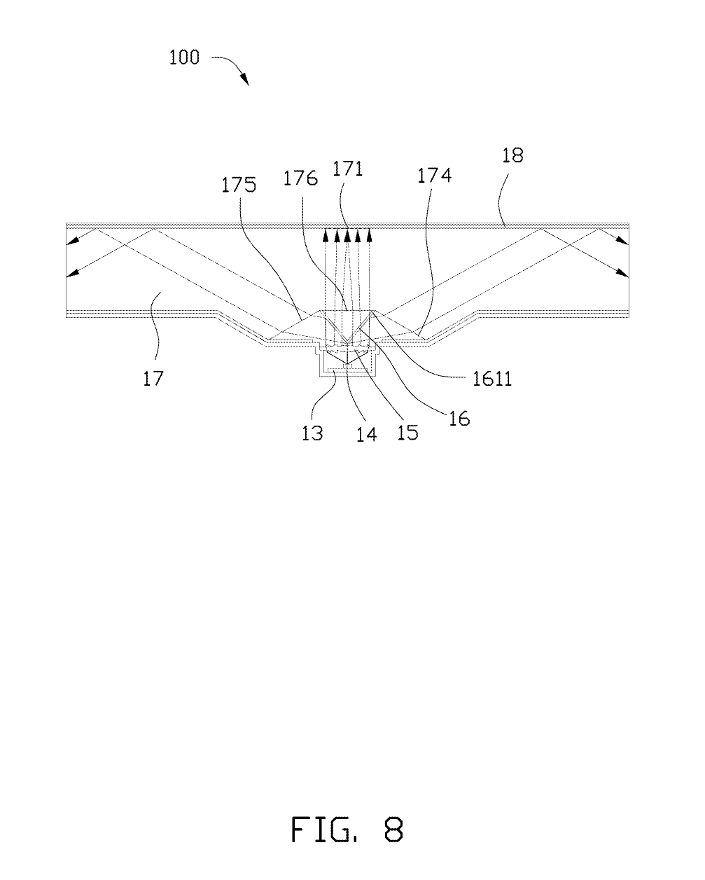

FIG. 8 illustrates the beam path of the backlight module 100 according to the first embodiment. The light beams output from the light source 14 on the lamp shade 13 via the refraction of the collimating lens 15 can be redirected to parallel light beams substantially perpendicular to the third light incident portion 176. A part of the parallel light beams can be output to the section of the reflector 16 beside the transmission holes 1611 and reflected into two side light beams. The two side light beams can enter the light guiding plate 17 via the first light incident portion 174 and the second light output portion 175. The light into the light guiding plate 17 can be diffused in the light guiding plate 17 via the total internal reflection (TIR) by the reason that the incidence angle in the light output surface 171 is larger than the critical angle of the total internal reflection. In addition, the light from the light guiding plate 17 can be diffused in the optical film 18. Simultaneously, the remainder of the parallel light beams can be input to the section above the reflector 16 through the light transmission hole 1611 of the reflector 16.

A plurality of reflective pattern dots (not shown) can be positioned on the surface of the light output surface 171 of the light guiding plate 17, or the surface of the diffusion sheet 181 adjacent to the light guiding plate 17, to improve the optical uniformity of the section above the reflector 16. In addition, a plurality of continuous arched or V-shaped striations (not shown) can be positioned on the surface of the third light incident portion 176.

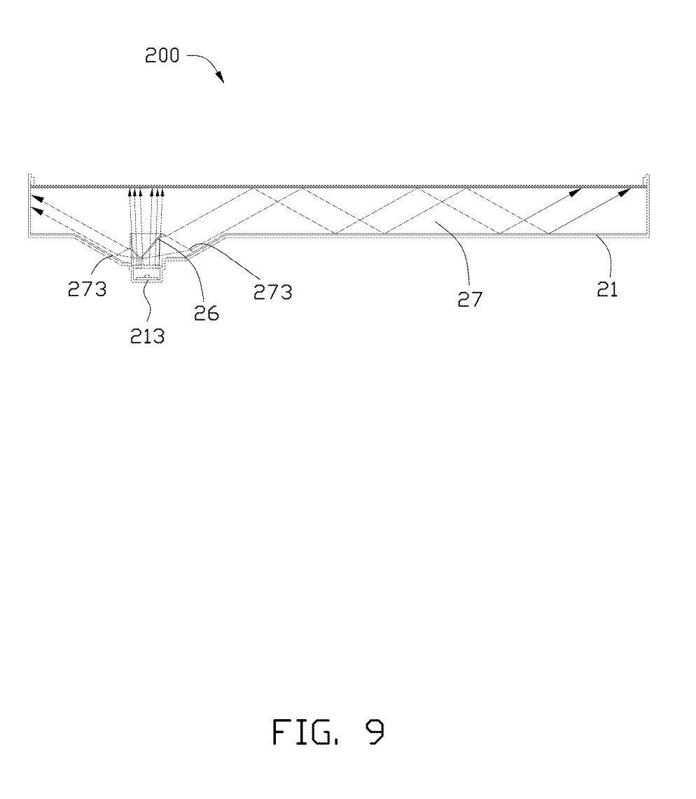

FIG. 9 illustrates the beam path of a backlight module 200 according to a second embodiment. The backlight module 200 is similar to that of the first embodiment, except that the light guiding plate 27 can further include two asymmetrical protrusion portions 273. In addition, the recessed portion 213 can be positioned between the center section and the rim section of the back cover 21. The reflector 26 can be prism groove-shaped and the cross-section of the reflector 26 is quadrangular. The reflector 26 can include three asymmetrical second sidewalls, and the second sidewalls are rectangular. Thus, the reflector 26 can adjust the luminous flux of incident light of the lateral section of the reflector 26 so that luminance of the light output surface of the light guiding plate 27 can be uniform and the assembly of the backlight module 200 can be easier and simpler than the conventional backlight module.

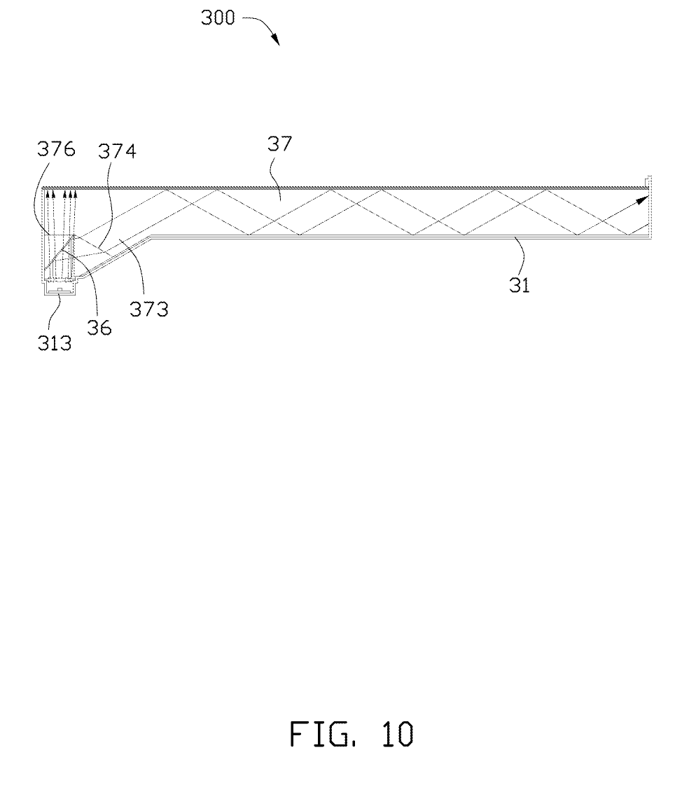

FIG. 10 illustrates a backlight module 300 according to a third embodiment. The backlight module 300 can be similar to that of the first embodiment, except that recessed portion 313 can be positioned on the rim of the back cover 31. In addition, a section adjacent to the rim of the light guiding plate 37 can define a protrusion portion 373. One side surface of the protrusion portion 373 can be defined as the first light incident portion 374. The section adjacent to the first light incident portion 374 and the rim of the light guiding plate 37 can be defined as the third incident portion 376. The reflector 36 can be secured on the back cover 31, can be rectangular plate-shaped, and the reflector 36 can be defined by a plurality of light transmission holes arranged in an array. Therefore, the luminance of the light output surface of the light guiding plate 37 can be uniform. In addition, the backlight module 300 according to the third embodiment can simplify the structure of the light guiding plate and the reflector. Moreover, the assembly of the backlight module 300 can be more convenient.

The light guiding plate of the backlight module according to the disclosure can include at least one prism-shaped protrusion portion and at least two light incident portions. In addition, a reflector can be positioned between the light source and one light incident portion, and the collimating lens can be installed between the light source and the reflector. Therefore, the reflector and the collimating lens can adjust the transmission direction of the light beams from the light source whereby the light beams entering the light guiding plate diffuse in the total internal reflection. In addition, the light output from the light guiding plate can transmit through the optical film. Thus, the backlight module can have a narrow bezel and thin design.

The embodiments shown and described above are only examples. Many details are often found in the art such as the other features of a backlight module. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A backlight module comprising:
a back cover;
a reflective sheet attached to the back cover;
a lamp shade position on the back cover;
a plurality of light sources mounted on the lamp shade;
a light guiding plate, with a first face of the light guiding plate facing the light sources;
a reflector; and
a collimating lens;
wherein, at least one substantially triangular prism protrusion extends from the first face of light guiding plate and the first face of guiding plate includes at least two light incident portions;
wherein, the collimating lens is substantially positioned between a substantial portion of the plurality of light sources and the reflector; and
wherein, the reflector includes a plurality of light transmission portions and is substantially positioned above a substantial portion of the plurality of light sources and is positioned below one of the at least two light incident portions of the light guiding plate.

2. The backlight module as claimed in claim 1, wherein:
the protrusion portions are integrated with the light guiding plate and the number of the protrusion portions is two;
the surfaces of the two protrusion portions facing each other are a first light incident portion and a second light incident portion;
the first light incident portion and the second light incident portion are inclined with the light input surface of the light guiding plate, and an area between the first light incident portion and the second light incident portion is defined as a third light incident portion; and
the third light input portion is positioned facing to the plurality of the light sources.

3. The backlight module as claimed in claim 2, wherein the third light incident portion is parallel with the light input surface of the light guiding plate and faces the reflector.

4. The backlight module as claimed in claim 2, wherein the surface of the third light incident portion defines a plurality of continuous arched striations.

5. The backlight module as claimed in claim 1, wherein:
the protrusion portion is one and integrated with the light guiding plate, and the protrusion portion is positioned adjacent to the rim of the light guiding plate;
one surface of the protrusion portion is defined as a first light incident portion, and the first light incident portion is inclined with the light input surface of the light guiding plate; and
a section adjacent to the rim of the light guiding plate is defined as a third light incident portion adjacent to the first light incident portion;
wherein the third light incident portion is positioned facing toward the plurality of the light sources.

6. The backlight module as claimed in claim 5, wherein the third light incident portion is parallel with the light input surface of the light guiding plate and faces the reflector.

7. The backlight module as claimed in claim 5, wherein the surface of the third light incident portion define a plurality of continuous V-shaped striations.

8. The backlight module as claimed in claim 1, wherein the reflector comprises two second sidewalls and two third sidewalls, and the cross-section of the reflector is v-shaped.

9. The backlight module as claimed in claim 1, wherein the plurality of light transmission holes are defined on the each of the second sidewalls.

10. The backlight module as claimed in claim 1, wherein the reflector is groove-shaped and comprises three second sidewalls; the second sidewalls are rectangular and the cross-section of the reflector is quadrangular.

11. The backlight module as claimed in claim 1, wherein the reflector is rectangular plate-shaped.

12. The backlight module as claimed in claim 1, wherein the plurality of light transmission holes are arranged in an array.

13. The backlight module as claimed in claim 1, wherein the bottom of the back cover defines a recessed portion, and the recessed portion is rectangular groove-shaped; the lamp shade and the plurality of light sources are received in the recessed portion, and the collimating lens is supported on the recessed portion.

14. The backlight module as claimed in claim 1, wherein the backlight module comprises a plastic frame coupled with the back cover.

15. The backlight module as claimed in claim 14, wherein the backlight module comprises an optical film positioned above the light guiding plate, and the optical film is fixed in the back cover by the plastic frame.

16. The backlight module as claimed in claim 15, wherein the light guiding plate comprises a light input surface facing toward the plurality of the light sources and a light output surface opposite to the light input surface.

17. The backlight module as claimed in claim 16, wherein the optical film includes a plurality of diffusion sheets and a plurality of prism sheets alternatively positioned, and one of the diffusion sheets is positioned adjacent to the light output surface.
